(19) United States
(12) Patent Application Publication
(10) Pub. No.: US 2006/0168576 A1
(43) Pub. Date: Jul. 27, 2006

(54) Method of updating a computer system to a qualified state prior to installation of an operating system

(75) Inventors: Hai Thanh Phung, Austin, TX (US); Manoj Gujarathi, Round Rock, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 11/044,141

(22) Filed: Jan. 27, 2005

(51) Int. Cl. G06F 9/44

(52) U.S. Cl. 717/168

(57) ABSTRACT

A method of updating a computer system to a qualified state prior to installation of an operating system (OS) is disclosed. In accordance with one embodiment, a method of updating an information handling system to a qualified state prior to installation of an OS including performing an inventory of the information handling system for installed system components in a pre-installation environment. The method further including automatically determining a compatibility relationship between the installed system components and available drivers. The method further including recommending an alternative driver based on the compatibility relationship. The method further including updating drivers in the information handling system such that the alternative driver installs on the information handling system to bring the information handling system to a qualified state based on the acceptance of the recommendation. The method further including installing the OS on the information handling system based on the qualified state.

### TECHNICAL FIELD

The present disclosure relates generally to information handling systems and, more particularly, to a method of updating a computer system to a qualified state prior to installation of an operating system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems, including computer systems, typically use various deployment or installation techniques for operating systems (OS) that help a user set up a system to their configuration. Arguably, the installation and updating of system device drivers are considered the most important task of the OS deployment process.

Typically in the enterprise computer world, the device drivers have dependencies on information handling system components such as a system basic input/output system (BIOS) and/or the system firmware. Generally, the drivers require that these components be updated, usually to a minimum level, before the drivers can be installed properly.

However, when deploying or installing an OS in the information handling system problems may occur. For example, the deployment process might fail or finish abnormally due to an incompatibility between the system BIOS and the system device drivers. Additionally, an incompatibility may occur between a driver of remote access controller and the current version of the system firmware.

The updating process typically requires a high degree of user interaction and knowledge of the system components. When updating the system, a user generally has to ensure that the system components and drivers meet the requirements for the OS deployment process such that the system is in a qualified state. For example, a user may be required to know the version of random array of inexpensive/independent disk (RAID) driver, the version of the remote access controller and the version of the system BIOS or firmware installed for the system components in order to place the system in a qualified state.

Further, the process of manually updating the server can be very cumbersome. For example, current versions of the firmware or BIOS may have to be downloaded to the system. Additionally, the updating process is usually performed from a boot of the system to a disk operating system (DOS) environment. In other instances, the process of updating the system requires that the firmware be updated or that the BIOS be flashed.

In sum, the updating process is an error prone and time consuming process that demands knowledge about the information handling system such as driver versions and compatibility between system components.

### SUMMARY

In accordance with one embodiment of the present disclosure, a method of updating an information handling system to a qualified state prior to installation of an operating system (OS) including performing an inventory of the information handling system for installed system components in a pre-installation environment. The method further including automatically determining a compatibility relationship between the installed system components and available drivers. The method further including recommending an alternative driver for use with at least one of the installed system components based on the compatibility relationship between the at least one of the installed system component and the associated available driver. The method further including updating drivers in the information handling system such that the alternative driver installs on the information handling system to bring the information handling system to a qualified state based on the acceptance of the recommendation. The method further including installing the OS on the information handling system based on the qualified state.

In a further embodiment, an information handling system includes a processor coupled to a processor bus and a memory coupled to the processor bus. The memory communicatively coupled with the processor. The processor able to execute instructions for updating the information handling system to a qualified state prior to installation of an operating system (OS). The instructions including performing an inventory of the information handling system for installed system components in a pre-installation environment. The instructions further including determining a compatibility relationship between the installed system components and available drivers. The instructions further including recommending an alternative driver for use with at least one of the installed system components based on the compatibility relationship between the at least one of the installed system component and the associated available driver. The instructions further including updating drivers in the information handling system such that the alternative driver installs on the information handling system to bring the information handling system to a qualified state based on the acceptance of the recommendation. The instructions further including installing the OS on the information handling system based on the qualified state.

In accordance with a further embodiment of the present disclosure, a computer-readable medium having computer-executable instructions for a method of updating an information handling system to a qualified state prior to installation of an operating system (OS), including instructions for performing an inventory of the information handling system for installed system components in a pre-installation environment. The computer-readable medium further including instructions for automatically determining a compatibility relationship between the installed system components and available drivers. The computer-readable medium further including instructions for recommending an alternative driver for use with at least one of the installed system components based on the compatibility relationship between the at least one of the installed system component and the associated available driver. The computer-readable medium further including instructions for updating drivers in the information handling system such that the alternative driver installs on the information handling system to bring the information handling system to a qualified state, wherein the updating is based on the acceptance of the recommendation. The computer-readable medium further including instructions for installing the OS on the information handling system.

One technical advantage of the present disclosure is the ability to perform a deployment of an operating system in one seamless step. In one-embodiment of the present disclosure, a compact disk (CD) may include any CD carrying a pre-OS installation support application that captures user preferences to facilitate OS installation. For example, a Dell Server Assistant (DSA) CD may be used to load the pre-operating system environment containing updated driver information and drivers used to update the server to a qualified state. Use of the CD may allow users to experience an enhanced satisfaction with the information handling system in addition to having a reduced installation time.

Another technical advantage of some embodiments of the present disclosure is the simplicity of use to avoid support calls to the manufacturer from users. Because the method determines the compatibility relationship between system drivers and installed components, the user does not need to have intimate knowledge of the system being deployed or an understanding of compatibility relationship between drivers and components. For example, the method will automatically recommend a driver for use with the components, such that a user does not have to call technical support for information regarding certain aspects of the BIOS or firmware compatibility requirements. Additionally, the manufacturer may avoid calls from the user because errors caused during the installation of the operating system may be avoided.

A further technical advantage of some embodiments of the present disclosure are an decreased installation or deployment time of the operating system (OS). Because the information handling system is pre-qualified prior to installation of the OS, the installation is more efficient and productive. Typically, a system that is pre-qualified prior to OS deployment is less prone to errors. Additionally, in some embodiments, a pre-qualified system may further reduce deployment time of software on a system.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram showing an information handling system, according to teachings of the present disclosure; and

FIG. 2 is a flowchart for a method of updating the information handling system to a qualified state prior to installation of an operating system, according to teachings of the present disclosure.

### DETAILED DESCRIPTION

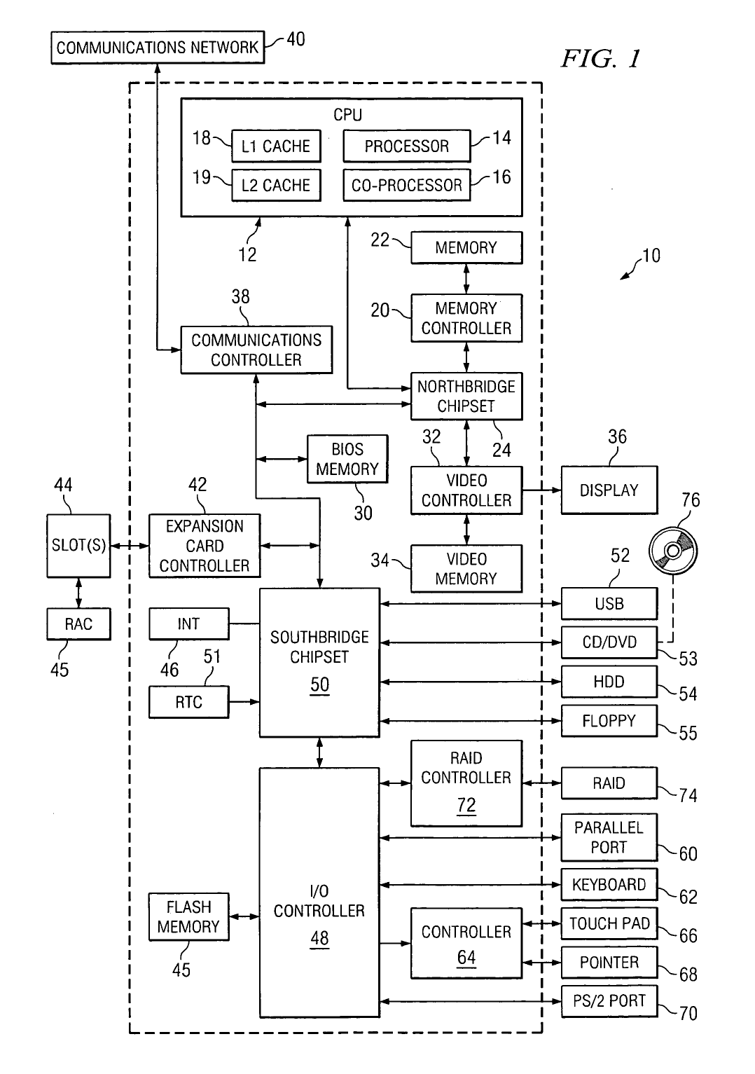

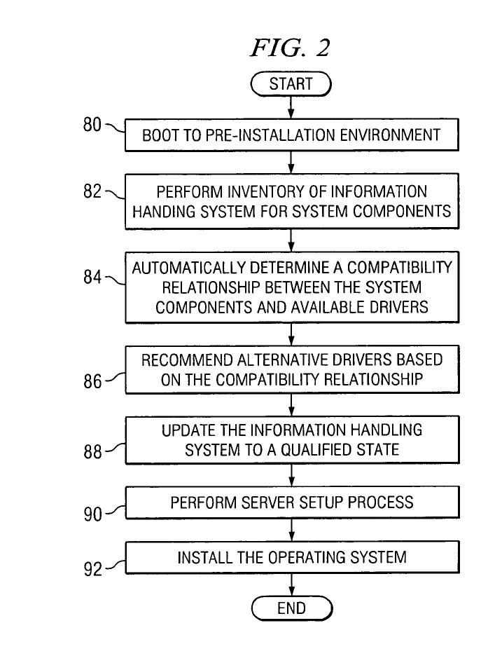

Preferred embodiments and their advantages are best understood by reference to FIGS. 1 through 2, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, a block diagram of information handling system 10 is shown, according to teachings of the present disclosure. Information handling system 10 or computer system preferably includes one or more microprocessors such as central processing unit (CPU) 12. CPU 12 may include processor 14 for handling integer operations and coprocessor 16 for handling floating point operations. CPU 12 is preferably coupled to cache, such as L1 cache 18 and L2 cache 19 and a chipset, commonly referred to as Northbridge chipset 24, via a frontside bus. Northbridge chipset 24 preferably couples CPU 12 to memory 22 via memory controller 20. Main memory 22 of dynamic random access memory (DRAM) modules may be divided into one or more areas such as system management mode (SMM) memory area (not expressly shown).

Graphics controller 32 is preferably coupled to Northbridge chipset 24 and to video memory 34. Video memory 34 is preferably operable to store information to be displayed on one or more display panels 36. Display panel 36 may be an active matrix or passive matrix liquid crystal display (LCD), a cathode ray tube (CRT) display or other display technology. In selected applications, uses or instances, graphics controller 32 may also be coupled to an integrated display, such as in a portable information handling system implementation.

Northbridge chipset 24 serves as a “bridge” between CPU bus 23 and the connected buses. Generally, when going from one bus to another bus, a bridge is needed to provide the translation or redirection to the correct bus. Typically, each bus uses its own set of protocols or rules to define the transfer of data or information along the bus, commonly referred to as the bus architecture. To prevent communication problem from arising between buses, chipsets such as Northbridge chipset 24 and Southbridge chipset 50, are able to translate and coordinate the exchange of information between the various buses and/or devices that communicate through their respective bridge.

Basic input/output system (BIOS) memory 30 is also preferably coupled to PCI bus connecting to Southbridge chipset 50. FLASH memory or other reprogrammable, nonvolatile memory may be used as BIOS memory 30. A BIOS program (not expressly shown) is typically stored in BIOS memory 30. The BIOS program preferably includes software which facilitates interaction with and between information handling system 10 devices such as a keyboard 62, a mouse such as touch pad 66 or pointer 68, or one or more I/O devices. BIOS memory 30 may also store system code (note expressly shown) operable to control a plurality of basic information handling system 10 operations.

Communication controller 38 is preferably provided and enables information handling system 10 to communicate with communication network 40, e.g., an Ethernet network. Communication network 40 may include a local area network (LAN), wide area network (WAN), Internet, Intranet, wireless broadband or the like. Communication controller 38 may be employed to form a network interface for communicating with other information handling systems (not expressly shown) coupled to communication network 40.

In certain information handling system embodiments, expansion card controller 42 may also be included and is preferably coupled to PCI bus 25 as shown. Expansion card controller 42 is preferably coupled to a plurality of information handling system expansion slots 44. Expansion slots 44 may be configured to receive one or more computer components such as an expansion card (e.g., modems, fax cards, communications cards, and other input/output (I/O) devices).

In some embodiments, remote access card (RAC) 45 connects to slots 44, such as at a peripheral component interface (PCI) port. RAC 45 typically allows for remote access to information handling system 10 including when system 10 is inoperable. As such, RAC 45 provides remote access to activate or start system 10. Some RAC 45, including a Dell™ remote access card III, provide alert notifications of system 10 if a problem is detected.

Southbridge chipset 50, also called bus interface controller or expansion bus controller preferably couples PCI bus 25 to an expansion bus. In one-embodiment, expansion bus may be configured as an Industry Standard Architecture (“ISA”) bus. Other buses, for example, a Peripheral Component Interconnect (“PCI”) bus, may also be used.

Interrupt request generator 46 is also preferably coupled to Southbridge chipset 40. Interrupt request generator 46 is preferably operable to issue an interrupt service request over a predetermined interrupt request line in response to receipt of a request to issue interrupt instruction from CPU 12. Southbridge chipset 40 preferably interfaces to one or more universal serial bus (USB) ports 52, CD-ROM (compact disk-read only memory) or digital versatile disk (DVD) drive 53, an integrated drive electronics (IDE) hard drive device (HDD) 54 and/or a floppy disk drive (FDD) 55. In one example embodiment, Southbridge chipset 40 interfaces with HDD 54 via an IDE bus (not expressly shown). Other disk drive devices (not expressly shown) which may be interfaced to Southbridge chipset 40 include a removable hard drive, a zip drive, a CD-RW (compact disk-read/write) drive, and a CD-DVD (compact disk-digital versatile disk) drive.

Real-time clock (RTC) 51 may also be coupled to Southbridge chipset 50. Inclusion of RTC 51 permits timed events or alarms to be activated in the information handling system 10. Real-time clock 51 may be programmed to generate an alarm signal at a predetermined time as well as to perform other operations.

I/O controller 48, often referred to as a super I/O controller, is also preferably coupled to Southbridge chipset 50. I/O controller 48 preferably interfaces to one or more parallel port 60, keyboard 62, device controller 64 operable to drive and interface with touch pad 66 and/or pointer 68, and PS/2 Port 70. FLASH memory or other nonvolatile memory may be used with I/O controller 48.

RAID 74 may also couple with I/O controller using interface RAID controller 72. In other embodiments, RAID 74 may couple directly to the motherboard (not expressly shown) using a RAID-on-chip circuit (not expressly shown) formed on the motherboard.

Generally, chipsets 24 and 50 may further include decode registers to coordinate the transfer of information between CPU 12 and a respective data bus and/or device. Because the number of decode registers available to chipset 24 or 50 may be limited, chipset 24 and/or 50 may increase the number or I/O decode ranges using system management interrupts (SMI) traps.

In one embodiment of the present disclosure, compact disk (CD) 76 may include any CD carrying a pre-OS installation support application that captures user preferences to facilitate OS installation. For example, a server assistant such as a Dell Server Assistant (DSA) compact-disk (CD) includes one or more programs that updates the server to a qualified state prior to installing an operating system. CD 76 may be placed into CD-ROM or DVD drive 53 such that the programs on the CD executes on CPU 12 and memory 22. The programs are able to determine a compatibility relationship between the system components such as RAID 74 and RAID controller 72 and the drivers installed on the server. As such, the programs on the DSA CD may cause the drivers to be updated to bring the server to a qualified state.

In another embodiment, the pre-OS installation support application that captures user preferences to facilitate OS installation may be remotely connected to system 10. For example, RAC 45 may be used to remotely start system 10 and update the server to a qualified state prior to installing an operating system.

FIG. 2 is a flowchart for a method of updating information handling system 10 to a qualified state prior to installation of an operating system (OS). In some embodiments, the method is stored on computer-readable medium having computer-executable instructions for performing the method.

At block 80, the method boots information handling system 10 to a pre-installation environment such as a during a server setup process. In one embodiment, the server is rebooted to start from a CD-ROM disk including an OS pre-installation application.

An inventory is performed of information handling system 10 for system components coupled with system 10, as shown at block 82. In some embodiments, the inventory of system 10 is performed by a program. For example, a small utility application may be invoked after the pre-installation environment is loaded. The application may collect the inventory of the system components including the basic input/output system (BIOS) and other firmware components.

During the inventory, the method typically searches information handling system 10 and pulls the inventory of BIOS, system firmware such as an enterprise security manager (ESM) and baseboard management controller (BMC) and other firmware such as firmware for remote access hardware or other hardware devices.

The method automatically determines a compatibility relationship between the inventoried system components and the available drivers as shown at block 84. Typically, the compatibility relationship is determined using a core task of established protocol. The protocol is a relationship between the enumerated BIOS and firmware versions installed in information handling system 10, namely the system components, and the latest drivers that are available for these devices usually the hardware devices for a given system such as a server system. Generally, the latest drivers for each of the system components such as a vendor-specific device are stored in the same media having the OS pre-installation application.

In some embodiments, the protocol may use a processing system that includes information regarding the compatibility and dependency relationships between the system components and the drivers required to be installed with the OS. Typically, the processing system may be selected and suited for particular information handling system such as a server including a RAID drive.

In other embodiments, the protocol may use an algorithm to determine the compatibility relationship between the existing or installed system components on system 10 and up-to-date drivers available to be installed. To determine this relationship, dependencies on system components may be located for each driver or other component having such dependency, such that the greatest common dependency version for each installed system component is selected.

Based on the compatibility relationship, the method recommends alternative drivers for use with the installed system components as shown at block 86. Typically, the recommendation for the updated drivers is presented to a user for confirmation to install the updated drivers. In other embodiments, the recommendations may be separated for individual selection of particular drivers for installation.

Typically, the recommendations are stored or saved for preservation to a log such as a system log which may be reviewed at a later time.

Based on the selected or confirmed drivers, the method updates the drivers for use with the system components in information handling system 10 such that information handling system 10 updates to a qualified state as shown at block 88. Generally, the drivers installed for use with system 10 are copied from the media having the pre-installation application.

Following the system update, the method performs a setup process such as a server setup as shown at block 90. Because system 10 has been updated to a qualified state, the deployment or installation of the OS may begin as shown at block 92.

Although the disclosed embodiments have been described in detail, it should be understood that various changes, substitutions and alterations can be made to the embodiments without departing from their spirit and scope.

What is claimed is:

1. A method of updating an information handling system to a qualified state prior to installation of an operating system (OS), comprising:
performing an inventory of the information handling system for installed system components in a pre-installation environment;
automatically determining a compatibility relationship between the installed system components and available drivers;
recommending an alternative driver for use with at least one of the installed system components based on the compatibility relationship between the at least one of the installed system component and the associated available driver;
based on the acceptance of the recommendation, updating drivers in the information handling system such that the alternative driver installs on the information handling system to bring the information handling system to a qualified state; and
based on the qualified state, installing the OS on the information handling system.

2. The method of claim 1, wherein installed system components comprise at least one component selected from a group of components consisting of a basic input/output system (BIOS), firmware, hardware devices and remote devices.

3. The method of claim 1, wherein the performing the inventory further comprises retrieving required information for each installed system component.

4. The method of claim 1, further comprising performing a server setup process prior to installation of the OS.

5. The method of claim 4, wherein the server setup process further comprises:
setting up a random array of inexpensive/independent disk (RAID) drive system; and
gathering system configuration information.

6. The method of claim 1, further comprising performing an OS configuration interview to setup details regarding user configuration of the information handling system.

7. The method of claim 1, wherein the performing the inventory further comprises loading a utility application in the pre-installation environment.

8. The method of claim 1, further comprising saving data gathered from the inventory in a log.

9. An information handling system, comprising:
a processor coupled to a processor bus;
a memory coupled to the processor bus, the memory communicatively coupled with the processor;
the processor operable to execute instructions for updating the information handling system to a qualified state prior to installation of an operating system (OS), the instructions comprising:
performing an inventory of the information handling system for installed system components in a pre-installation environment;
determining a compatibility relationship between the installed system components and available drivers;
recommending an alternative driver for use with at least one of the installed system components based on the compatibility relationship between the at least one of the installed system component and the associated available driver;
based on the acceptance of the recommendation, updating drivers in the information handling system such that the alternative driver installs on the information handling system to bring the information handling system to a qualified state; and
based on the qualified state, installing the OS on the information handling system.

10. The information handling system of claim 9, further comprising the installed system components including a basic input/output system (BIOS), firmware, hardware devices or remote devices.

11. The information handling system of claim 9, further comprising:
a computer device operably coupled to the processor and memory; and
the computer device operable to retrieve data from a computer readable medium, the computer readable medium including applications for establishing the pre-installation environment.

12. The information handling system of claim 11, wherein the computer readable medium further comprises a plurality of drivers for computer components.

13. The information handling system of claim 9, wherein the computer readable medium further comprises a utility application operably including instructions to perform the inventory of the information handling system.

14. The information handling system of claim 13, further comprising a log of data from the inventory.

15. A computer-readable medium having computer-executable instructions for a method of updating an information handling system to a qualified state prior to installation of an operating system (OS), comprising:
instructions for performing an inventory of the information handling system for installed system components in a pre-installation environment;
instructions for automatically determining a compatibility relationship between the installed system components and available drivers;
instructions for recommending an alternative driver for use with at least one of the installed system components based on the compatibility relationship between the at least one of the installed system component and the associated available driver;
instructions for updating drivers in the information handling system such that the alternative driver installs on the information handling system to bring the information handling system to a qualified state, wherein the updating is based on the acceptance of the recommendation; and
instructions for installing the OS on the information handling system.

16. The computer-readable medium of claim 15, wherein the instructions for performing the inventory further comprises instructions for retrieving required information for each installed system.

17. The computer-readable medium of claim 15, further comprising instructions for performing a server setup process prior to installation of the OS.

18. The computer-readable medium of claim 15, further comprising instructions for performing an OS configuration interview to setup details regarding user configuration of the information handling system.

19. The computer-readable medium of claim 15, further comprising instructions for establishing the pre-installation environment.

20. The computer-readable medium of claim 15, further comprising instructions for saving data gathered from the inventory in a log.
